(19) United States
(12) Patent Application Publication
(10) Pub. No.: US 2024/0140375 A1
(43) Pub. Date: May 2, 2024

(54) METHOD FOR CONTROLLING A HYDRAULIC VOLUME

(71) Applicant: Robert Bosch GmbH, Stuttgart (DE)

(72) Inventors: Ralf Kinder, Auenstein (DE); Herbert Vollert, Vaihingen/Enz (DE); Markus Weigel, Loechgau (DE)

(21) Appl. No.: 18/548,144

(22) PCT Filed: Mar. 17, 2022
(86) PCT No.: PCT/EP2022/056913

§ 371 Date: Aug. 28, 2023

(30) Foreign Application Priority Data
Jun. 30, 2021 (DE) 10 2021 206 811.1

(51) Int. Cl. B60T 8/1755; B60T 17/22; F15B 15/20

(52) U.S. Cl. CPC B60T 8/1755; B60T 17/22; F15B 15/20; B60T 2260/08; B60T 2270/402; B60T 2270/413

(57) ABSTRACT

A method for controlling a hydraulic volume in a system comprising a power brake and a driving dynamics control. The system is configured to hydraulically couple the power brake to the driving dynamics control. The method includes: providing a signal to build up a first dynamic pressure for the driving dynamics control; generating a first control signal by means of the driving dynamics control, and providing the first control signal to the power brake in order to provide the hydraulic volume at the hydraulic coupling; generating a second hydraulic pressure by means of the power brake in order to provide the hydraulic volume at the hydraulic coupling; providing the hydraulic volume at the second hydraulic pressure at the hydraulic coupling by means of the power brake; and building up the first hydraulic pressure in the driving dynamics control by means of the provided hydraulic volume.

### BACKGROUND INFORMATION

In addition to stabilizing functions, e.g., in the form of a traditional ESP/ABS function, current vehicle brake systems increasingly contain expanded functions, such as support of the driver, or application of force to the brake pedal during the brake actuation by an eBKV (electromechanical brake booster) or also assisted or partially assisted functions by means of a unit for active modulation of the hydraulic brake pressure (e.g., ESP, eBKV, boost unit, etc.), without active involvement of the driver.

Driver assistance systems are increasingly used in different stages in modern motor vehicles. They intervene in a partially automated or automated manner in the drive, control (e.g., steering) or signaling devices of the vehicle or warn the driver by means of suitable human-machine interfaces shortly before or during critical situations. Typically, a brake system has an electronic brake booster (eBKV) and an ESP system. In this combination, the majority of the brake system functions can be realized by means of an ESP system and the brake booster is used as an external controller to build up dynamic pressure.

In this case, brake systems can operate with a closed hydraulic system, i.e., a reservoir with hydraulic fluid of the brake system is only used for leakage and temperature compensation and an available hydraulic volume is thus constant. Examples in this respect are traditional brake systems, such as vacuum brake boosters, electromechanical brake boosters, such as the iBooster, or also a decoupled power brake (DPB) combined with an ESP system. Alternatively, brake systems can operate with an open hydraulic system, such as IPB (integrated power brake) systems. In this case, a reservoir with hydraulic fluid can be used in normal operation to temporarily store hydraulic volumes. The utilized hydraulic volume of the brake system can thus change during braking. Respective brake systems have different disadvantages; for example, systems with a closed hydraulic system have the problem that a suction of an ESP system, depending on the operation, should have more hydraulic volume in the relevant region of the brake system, i.e., below the master brake cylinder up to the brake cylinders on the wheels, than should be present in normal operation.

### SUMMARY

According to aspects of the present invention, a method for controlling a hydraulic volume in a system comprising a power brake and a driving dynamics control, a system for controlling a hydraulic volume in a system comprising a power brake and a driving dynamics control, and a use of the system for controlling a hydraulic volume according to the features of the present invention are provided. Advantageous embodiments of the present invention are disclosed herein.

Throughout this description of the present invention, the sequence of method steps is shown in such a way that the method is easy to understand. However, the person skilled in the art will recognize that many of the method steps can also be run through in a different order and result in the same or a corresponding result. In this sense, the sequence of the method steps can be changed accordingly. Some features are provided with numbers to improve readability or make the assignment clearer, although this does not imply a presence of certain features.

According to one aspect of the present invention, a method for controlling a hydraulic volume in a system comprising a power brake and a driving dynamics control is proposed, wherein the system is configured to hydraulically couple the power brake to the driving dynamics control. In a step of the method for controlling a hydraulic volume, a signal to build up a first hydraulic pressure for the driving dynamics control is provided. In a further step, a first control signal is generated by means of the driving dynamics control, and the first control signal is provided to the power brake in order to provide hydraulic volume at the hydraulic coupling. In a further step, a second hydraulic pressure is generated by means of the power brake in order to provide the hydraulic volume at the hydraulic coupling. In a further step, the hydraulic volume at the second hydraulic pressure is provided at the hydraulic coupling by means of the power brake and the first hydraulic pressure is built up in the driving dynamics control by means of the provided hydraulic volume.

According to an example embodiment of the present invention, the power brake and/or the driving dynamics control can be configured to be coupled to one another in that a coupling valve of the power brake and a coupling valve of the driving dynamics control are configured to be hydraulically coupled to one another. That is to say, the hydraulic coupling of the system comprising the power brake and the driving dynamics control can be configured between the coupling valve of the driving dynamics control and the coupling valve of the power brake to hydraulically couple the power brake and the driving dynamics control to one another.

In particular, the power brake can provide a hydraulic volume to the driving dynamics control so that the hydraulic volume in the system remains constant when the first dynamic pressure is built up by the driving dynamics control. In other words, the power brake can regulate the provided hydraulic volume such that a sufficient hydraulic volume is provided to the driving dynamics control without additional hydraulic volume being added from an additional reservoir. That is to say, when the first dynamic pressure of the driving dynamics control is reduced again, the power brake can be configured to again receive the provided hydraulic volume without having to deliver it into the additional reservoir.

In particular, according to an example embodiment of the present invention, the system comprising the power brake and the driving dynamics control can be configured to transmit a signal to the power brake in the event of an activation of the driving dynamics control, such as a brake force modulation system, so that the power brake interacts hydraulically with the driving dynamics control such that a sufficient hydraulic volume is provided to the driving dynamics control to build up a first hydraulic pressure without the hydraulic volume in the system comprising the power brake and the driving dynamics control being changed.

Therefore, it can be ensured with this method for controlling the hydraulic volume that the hydraulic volume that is sucked by the driving dynamics control is provided from a plunger of the power brake and not from the hydraulic reservoir.

In other words, the system can be configured such that information that the driving dynamics control wants to suck hydraulic volume is ascertained and transmitted to the power brake, whereupon the plunger of the power brake is actively controlled to build up a sufficient but low second pressure so that the hydraulic volume is not removed from a hydraulic reservoir from the plunger since the second pressure that the plunger of the power brake generates is sufficiently high to avoid suction out of the hydraulic reservoir. This method for controlling the system results in a closed hydraulic system during the build-up of the first dynamic pressure of the driving dynamics control. There is thus no need to provide measures to transfer the sucked provided hydraulic volume back into the hydraulic reservoir in order to ensure that no hydraulic pressure is present in the rest position of the system. A plunger without sniffer bores can thus be used in this system, whereby, among other things, installation space and in particular width for the system can be saved.

According to an example embodiment of the present invention, advantageously, this method for controlling the hydraulic volume in the system results in no pressure remaining in the brake system after a release of the brake or after the operation of the driving dynamics control, and the functionality of the brake system thus being retained.

According to an example embodiment of the present invention, the system comprising the power brake and the driving dynamics control may be a 2-box design of a brake system, in which a decoupled electric brake booster (decoupled power brake; DPB) is combined with a standard driving dynamics control (electronic stability control (ESP) system).

The information that the driving dynamics control is activated in order to build up a first dynamic pressure can be transmitted via a communication interface to an actuator, such as the power brake, and in particular to the decoupled electric brake booster, which adjusts a low pressure, the second hydraulic pressure, by means of the plunger in order to avoid removal of the hydraulic volume from a hydraulic reservoir.

In particular, such a system may include, for example, a decoupled electric brake booster (decoupled power brake; DPB) as a power brake, in which the driver brakes into a simulator during normal operation and the actual brake pressure is generated by means of a plunger. This pre-pressure can be passed to a driving dynamics control via two brake lines. In such a brake system, brake pressure can be built up, independently of the operation of a brake pedal, by means of a plunger of the power brake or a pump of the driving dynamics control. In this case, the power brake can primarily assume a necessary dynamic build-up of a brake pressure. The driving dynamics control can provide stabilization functions and possibly required emergency functions, such as a build-up of a hydraulic brake pressure, in the event of a fault.

The driving dynamics control of the system can thus build up a required brake pressure, based on a driver's request, in an emergency.

According to an example embodiment of the present invention, alternatively or additionally, a brake system which is based on this system may be designed to build up the necessary brake pressure by means of the driving dynamics control in the event of a failure of the power brake or in the event of hydraulic leakage in the system that causes a legally prescribed minimum deceleration to no longer be enabled.

According to an example embodiment of the present invention, advantageously, with the system comprising the power brake and the driving dynamics control and the method for controlling the hydraulic volume, the hydraulic volume in the system can be kept constant when the driving dynamics control is operated. A driver of a vehicle with such a brake system does not notice this method since a master cylinder with a pedal for the driver is decoupled in the power brake from the plunger which is configured to build up a brake pressure.

Based on the request by the first control signal, the driving dynamics control can use a pump to build up the requested pressure by using hydraulic volume provided by the power brake for this purpose. In other words, the driving dynamics control can suck hydraulic volume out of the power brake.

According to an example embodiment of the present invention, since the system comprising the power brake and the driving dynamics control, e.g., as a brake system, is closed, an interface can be provided which makes it possible for the driving dynamics control to transmit a suction of hydraulic volumes, such as brake fluid, to the power brake. In this case, the power brake can be configured to prevent undesired, additional hydraulic volume from reaching the system, such as brake circuits.

For this purpose, the power brake can have a plunger and regulate it, in so-called suction support, such that no negative pressure arises in the system, or in particular in the power brake. This is because the power brake can be configured to suck hydraulic volume out of a storage tank through safety valves, such as BSV valves, in the event of a sufficient high negative pressure in the power brake. This possibility of sucking hydraulic volume, such as brake fluid, out of the storage tank can be provided for special situations and must be avoided in normal operation in order to ensure perfect functioning of the system.

According to an example embodiment of the present invention, when the first hydraulic pressure has been successfully built up in the driving dynamics control, the desired hydraulic pressure is applied, for example to the brake cylinders of the respective wheels, or in a respective hydraulic high-pressure circuit of the driving dynamics control. In this case, the second hydraulic pressure is controlled or regulated at the hydraulic coupling of the power brake, for example by means of a plunger, such that a hydraulic volume in the system remains constant. In other words, the hydraulic volume required for the pressure build-up in the driving dynamics is provided by a hydraulic volume from the plunger, the piston of which is moved accordingly for this purpose. In other words, the hydraulic volume required for the pressure build-up in the driving dynamics control is provided by the power brake, in particular by a hydraulic volume of the plunger, in that the piston of the plunger is moved to a front position, for example.

The second hydraulic pressure, which prevails in a region between the plunger of the power brake and the coupling valve SCC of the driving dynamics control, can in this case be regulated at a low level, for example by means of a pressure sensor of the power brake which is arranged in this region in order to determine the hydraulic pressure.

According to one aspect of the present invention, it is provided that the power brake is a decoupled electric brake booster (decoupled power brake; DPB) and/or the driving dynamics control is an ESP system (electronic stability control system).

According to one aspect of the present invention, it is provided that after a signal provided to the driving dynamics control for pressure reduction, the method for controlling the hydraulic volume:
generates a second control signal by means of the driving dynamics control and provides the second control signal to the power brake so that the power brake receives the hydraulic volume at the hydraulic coupling. In a further step, a third hydraulic pressure is generated by means of the power brake in order to receive hydraulic volume at the hydraulic coupling. In a further step, the hydraulic volume at the second hydraulic pressure is received by the power brake at the hydraulic coupling and the pressure in the driving dynamics control is reduced by means of the hydraulic volume received by the power brake.

In other words, after the pressure build-up has ended, the plunger can again receive the hydraulic volume that had been required by the driving dynamics control in order to build up the first dynamic pressure.

According to one aspect of the present invention, it is provided that the hydraulic volume is provided by a plunger of the power brake.

According to one aspect of the present invention, it is provided that the plunger has no sniffer bore.

The plunger can thus advantageously be constructed smaller.

According to one aspect of the present invention, it is provided that the second hydraulic pressure and/or the third hydraulic pressure is generated by the plunger of the power brake.

In particular, the levels of the second hydraulic pressure and/or the third hydraulic pressure can be determined such that a minimum pressure for a functioning of a controller is reached in order to regulate the second hydraulic pressure and/or the third hydraulic pressure.

According to one aspect of the present invention, it is provided that the first control signal and/or the second control signal is provided by a control device to the driving dynamics control.

According to one aspect of the present invention, it is provided that the first control signal and/or the second control signal is provided by a signal at an activated changeover valve of the power brake and/or of the driving dynamics control.

Alternatively or additionally, the first control signal and/or the second control signal may thus be applied directly to an activated changeover valve, such as a coupling valve of the driving dynamics control SCC, and provided to the power brake.

According to one aspect of the present invention, it is provided that the activated changeover valve is a controllable valve of the driving dynamics control.

In particular, such an activated changeover valve may, for example, be a coupling valve of the driving dynamics control SCC.

According to one aspect of the present invention, it is provided that the first control signal and/or the second control signal is a binary signal and/or an analog signal.

In other words, the driving dynamics control and the power brake can be coupled by signals by means of a control line and/or a bus system for sending the first control signal and/or sending the second control signal. In this case, the first control signal and/or the second control signal can assume binary values and/or represent continuous values which are dependent on the dynamics of the suction process of the hydraulic volume.

According to one aspect of the present invention, it is provided that the second hydraulic pressure and/or the hydraulic volume is reached by mechanically moving a position of a piston of the plunger from an initial position in order to provide an increased pressure at the hydraulic coupling.

The hydraulic volume can thus be provided at an output of the plunger.

According to one aspect of the present invention, it is provided that the method also works with a manually operated master brake cylinder

According to one aspect of the present invention, it is provided that the second hydraulic pressure is determined by means of a pressure sensor in order to regulate the second hydraulic pressure.

According to one aspect of the present invention, it is provided that the signal to build up pressure for the driving dynamics control is provided by a control device of a mobile platform.

According to an example embodiment of the present invention, a system for controlling a hydraulic volume in a system comprising a power brake and a driving dynamics control is provided, with a power brake and a driving dynamics control, which is hydraulically coupled to the power brake. Furthermore, the system contains a control device for the driving dynamics control, wherein the power brake is coupled by signals to the driving dynamics control, and wherein the system is configured to perform one of the above-described methods for controlling the hydraulic volume.

According to an example embodiment of the present invention, a use of the system for controlling a hydraulic volume, as described above, for braking at least one wheel of a mobile platform is provided.

According to an example embodiment of A mobile platform, and in particular an at least partially automated vehicle, is proposed, which has an above-described device for controlling a hydraulic volume. Advantageously, such a mobile platform can realize all the advantages of the method for controlling a hydraulic volume.

A mobile platform can be understood to be an at least partially automated system which is mobile, and/or a driver assistance system of a vehicle. An example can be an at least partially automated vehicle or a vehicle with a driver assistance system. That is to say, in this context, an at least partially automated system includes a mobile platform with respect to an at least partially automated functionality, but a mobile platform also includes vehicles and other mobile machines, including driver assistance systems. Other examples of mobile platforms may include multi-sensor driver assistance systems, multi-sensor mobile robots such as robotic vacuum cleaners or lawn mowers, a multi-sensor monitoring system, a manufacturing machine, a personal assistant or an access control system. Each of such systems can be a fully or partially automated system.

### BRIEF DESCRIPTION OF THE DRAWINGS

Exemplary embodiments of the present invention are illustrated with reference to FIGS. 1 to 2 and explained in more detail below.

FIG. 1 shows a system comprising a power brake and a driving dynamics control in a rest state.

FIG. 2 shows a system comprising a power brake and a driving dynamics control during pressure build-up in the driving dynamics control.

### DETAILED DESCRIPTION OF EXAMPLE EMBODIMENTS

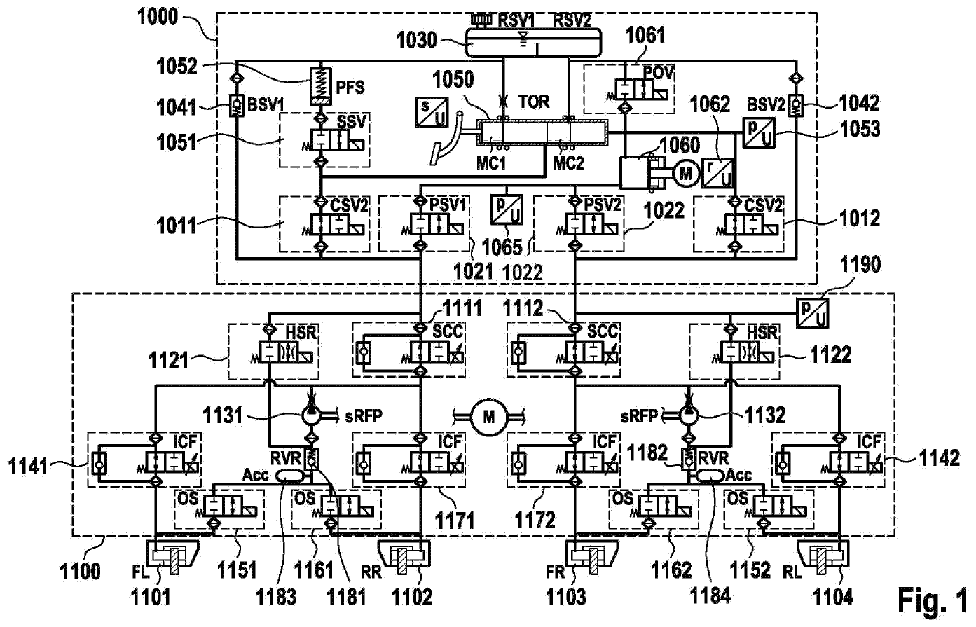

FIG. 1 schematically shows a system comprising a power brake 1000 and a driving dynamics control 1100 with valve positions in a rest state, wherein the system is configured to hydraulically couple the power brake 1000 to the driving dynamics control 1100 by means of a first and a second coupling valve of the power brake PSV 1, 2 1021 or 1022 and a first and a second coupling valve of the driving dynamics control SCC 1111 and 1112 and to thus form a hydraulic coupling.

In this case, both the power brake 1000 and the driving dynamics control 1100 are designed with two circuits.

A master cylinder 1050 can be operated manually by a pedal which is mechanically connected to the master cylinder, in order to act hydraulically by means of a first or a second circuit separation valve CSV 1, 2 1011 or 1012 by means of respectively assigned circuits of the driving dynamics control 1100 on brake cylinders 1101, 1102 or 1103 and 1104 in order to achieve an emergency braking effect. In this case, the master brake cylinder 1050 is hydraulically connected to a reservoir for hydraulic fluid 1030 by means of two sniffer bores.

In normal operation, the braking effect at the brake cylinders 1101, 1102 or 1103 and 1104 can be caused by means of a plunger 1060 in that the plunger 1060 displaces hydraulic volume via the coupling valves of the power brake PSV 1, 2 1021 or 1022 into the two circuits of the driving dynamics control. The plunger 1060 can be hydraulically coupled via a valve POV 1061 to the hydraulic reservoir RSV 1, 2 1030. The plunger 1060 is coupled to an electric motor in order to be able to deliver or receive hydraulic volume by means of a piston. The electric motor can be regulated by a controller which is coupled to a sensor system for determining the electric motor position RPS 1062. The pressure of the master cylinder 1050 can be determined by means of a pressure sensor 1053.

The two-circuit master cylinder 1050 can be hydraulically coupled via a valve SSV 1051 to a brake simulator PFS 1052 in order to simulate a hydraulic pressure build-up to a driver who operates the brake pedal. In normal operation, the hydraulic volume is then provided by means of the plunger 1060 for the driving dynamics control 1100 in order to achieve a braking effect at the brake cylinders 1101, 1102 or 1103 and 1104, which are hydraulically coupled to the driving dynamics control 1100. A mechanical position of the brake pedal can be determined by a displacement transducer s/U which is mechanically coupled to the brake pedal, in order to control the plunger 1060.

A second hydraulic pressure generated by the plunger 1060 can be determined by means of a plunger pressure sensor 1065. Hydraulic fluid can be additionally supplied to the hydraulic system comprising the power brake 1000 and the driving dynamics control 1100 by means of a first check valve BSV 1, 2 1041 and 1042.

The two circuits of the driving dynamics control 1100 largely correspond to each other so that it is sufficient to describe one circuit.

In at least one of the two circuits of the driving dynamics control 1100, a pressure at the hydraulic coupling can be determined by means of a pressure sensor 1190.

The power brake 1000 is hydraulically coupled by means of the coupling valve of the power brake PSV 1, 2 1021 or 1022 to the coupling valve of the driving dynamics control SCC 1111 or 1112, and thus forms a hydraulic coupling between the power brake 1000 and the driving dynamics control 1100.

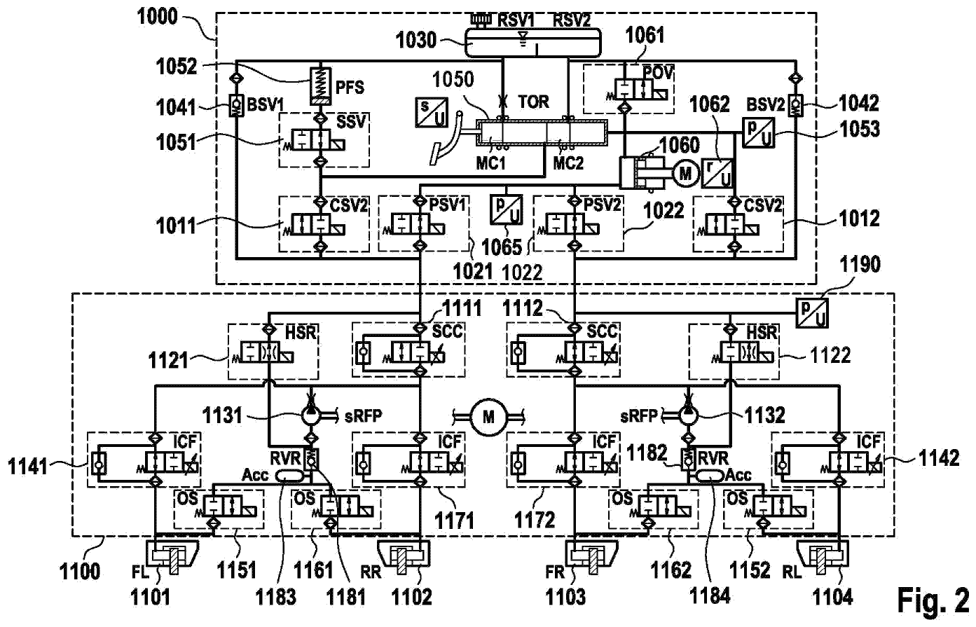

FIG. 2 describes valve positions for a build-up of the first dynamic pressure by means of the driving dynamics control 1100.

The driving dynamics control 1100 is configured to provide the first dynamic pressure for the driving dynamics control 1100 by means of the respective pump 1131 or 1132.

If the driving dynamics control 1100 is provided with a signal to build up the first dynamic pressure, for example by a controller of a mobile platform, the driving dynamics control 1100 generates a first control signal and provides this first control signal to the power brake 1000 so that the power brake 1000 provides a hydraulic volume at the hydraulic coupling.

In order to provide the hydraulic volume at the hydraulic coupling, a second hydraulic pressure is generated by means of the power brake 1000 with the plunger 1060, is checked by means of the plunger pressure sensor 1065, and is provided to the hydraulic coupling by the power brake 1000 at the hydraulic coupling of the driving dynamics control 1100 so that the driving dynamics control 1100 can build up the first hydraulic pressure by means of the provided hydraulic volume.

For this purpose, the respective coupling valve SCC 1111 or 1112 is closed and the high-pressure valve HSR 1121 or 1122 is opened in order to hydraulically couple the respective pump of the driving dynamics control 1131 or 1132 to the hydraulic coupling. In this case, the second hydraulic pressure, which is generated by the plunger 1060, is used to ensure that the required hydraulic volume is not removed from the reservoir 1030 but is provided by the plunger 1060 for the pressure build-up of the first dynamic pressure by the driving dynamics control 1100 since the second dynamic pressure prevents the respective check valves BSV 1, 2 1041 and 1042 from being opened.

The thus generated first hydraulic pressure of the driving dynamics control 1100 is provided via the respective open valves ICF 1141, 1171 or 1142, 1172 to the brake cylinders 1101, 1102 or 1103, 1104 in order to be able to achieve a braking effect.

If the driving dynamics control 1100 is provided with a signal to reduce pressure, the driving dynamics control 1100 generates a second control signal and provides this second control signal to the power brake 1000 so that the power brake 1000 receives hydraulic volume at the hydraulic coupling by means of the plunger 1060. For this purpose, the power brake 1000 can use the plunger 1060 to build up a third hydraulic pressure, which can be determined by the plunger pressure sensor 1065 in order for the hydraulic volume to be received by the brake cylinders 1101, 1102 or 1103, 1104 by means of the outlet valves OS 1151, 1161 or 1152, 1162 and possibly by means of a coupled buffer volume ACC 1183 or 1184 and through a check valve 1181 or 1182 by means of the respective pump of the driving dynamics control 1131 or 1132 via the respective open coupling valve SCC 1111 or 1112 and the open coupling valve of the power brake PSV 1, 2 1021 or 1022 from a volume of the plunger 1060, which can be adjusted by displacing a piston of the plunger, whereby the first pressure is reduced in the driving dynamics control 1100 by means of the hydraulic volume received by the power brake 1000.

In this case, the third hydraulic pressure can correspond to the second hydraulic pressure.

That is to say, the power brake 1000 can provide a hydraulic volume to the driving dynamics control 1100 so that the hydraulic volume in the system remains constant when the first dynamic pressure is built up by the driving dynamics control 1100. Thus, the power brake 1000 is configured to regulate the provided hydraulic volume such that a sufficient hydraulic volume is provided to the driving dynamics control 1100 to generate the first pressure without additional hydraulic volume being added from an additional reservoir 1030.

If the first dynamic pressure of the driving dynamics control 1100 is reduced again, the power brake 1000 can be configured to again receive the provided hydraulic volume without having to deliver it into the additional reservoir 1030.

1-14. (canceled)

15. A method for controlling a hydraulic volume in a system including a power brake and a driving dynamics control, wherein the system is configured to hydraulically couple the power brake to the driving dynamics control, the method comprising the following steps:
providing a signal to build up a first hudraulic pressure for the driving dynamics control;
generating a first control signal using the driving dynamics control, and providing the first control signal to the power brake to provide hydraulic volume at the hydraulic coupling;
generating a second hydraulic pressure using the power brake to provide the hydraulic volume at the hydraulic coupling;
providing the hydraulic volume at the second hydraulic pressure at the hydraulic coupling using the power brake; and
building up the first hydraulic pressure in the driving dynamics control using the provided hydraulic volume.

16. The method according to claim 15, further comprising:
providing a signal to reduce pressure for the driving dynamics control;
generating a second control signal using the driving dynamics control, and providing the second control signal to the power brake to receive the hydraulic volume at the hydraulic coupling;
generating a third hydraulic pressure using the power brake to receive the hydraulic volume at the hydraulic coupling;
receiving the hydraulic volume at the second hydraulic pressure at the hydraulic coupling using the power brake; and
reducing the first hydraulic pressure in the driving dynamics control using the hydraulic volume received by the power brake.

17. The method according to claim 15, wherein the hydraulic volume is provided by a plunger of the power brake.

18. The method according to claim 17, wherein the plunger does not have a sniffer bore.

19. The method according to claim 17, wherein the second hydraulic pressure and/or the third hydraulic pressure is generated by the plunger of the power brake.

20. The method according to claim 16, wherein the first control signal and/or the second control signal is provided by a control device of the driving dynamics control.

21. The method according to claim 16, wherein the first control signal and/or the second control signal is provided by a signal at an activated changeover valve of the power brake and/or of the driving dynamics control.

22. The method according to claim 21, wherein the activated changeover valve is a valve is a controllable valve of the driving dynamics control.

23. The method according to claim 16, wherein the first control signal and/or the second control signal is a binary signal and/or an analog signal.

24. The method according to claim 17, wherein the second hydraulic pressure and/or the hydraulic volume is reached by mechanically moving a position of a piston of the plunger from an initial position in order to provide an increased pressure at the hydraulic coupling.

25. The method according to claim 15, wherein the second hydraulic pressure is determined using a pressure sensor in order to regulate the second hydraulic pressure.

26. The method according to claim 15, wherein the signal to build up pressure for the driving dynamics control is provided by a control device of a mobile platform.

27. A system for controlling a hydraulic volume in a system including a power brake and a driving dynamics control, comprising:
a power brake;
a driving dynamics control hydraulically coupled to the power brake;
a control device for the driving dynamics control;
wherein the power brake is coupled by signals to the driving dynamics control; and
wherein the system is configured to:
provide a signal to build up a first hudraulic pressure for the driving dynamics control,
generate a first control signal using the driving dynamics control, and providing the first control signal to the power brake to provide hydraulic volume at the hydraulic coupling,
generate a second hydraulic pressure using the power brake to provide the hydraulic volume at the hydraulic coupling,
provide the hydraulic volume at the second hydraulic pressure at the hydraulic coupling using the power brake, and
build up the first hydraulic pressure in the driving dynamics control using the provided hydraulic volume.

28. The system as recited in claim 27, wherein the system is configured for braking at least one wheel of a mobile platform.
